(19) United States
(12) Patent Application Publication
(10) Pub. No.: US 2008/0305699 A1
(43) Pub. Date: Dec. 11, 2008

(54) Structure of Preventing Sticking and Method of Preparing the Same

(76) Inventors: Sang-woon Kwak, Seoul (KR); Ji-young Kwak, Suwon (KR); Min-soo Yang, Uijeongbu (KR); Min-seok Kwon, Seongnam (KR); Tae-kyung Kwak, Suwon (KR)

Correspondence Address: CANTOR COLBURN, LLP, 20 Church Street, 22nd Floor, Hartford, CT, 06103, US

(21) Appl. No.: 11/570,712

(22) PCT Filed: Jun. 17, 2005
(86) PCT No.: PCT/KR2005/001882

§ 371 Date: Aug. 7, 2008

(30) Foreign Application Priority Data
Jun. 17, 2004 (KR) 1020040044846
Nov. 12, 2004 (KR) 1020040092292
Jan. 6, 2005 (KR) 2020050000354
Jan. 14, 2005 (KR) 2020050001170
Feb. 17, 2005 (KR) 1020050013156
Feb. 17, 2005 (KR) 2020050004273
Apr. 7, 2005 (KR) 1020050028973
Apr. 12, 2005 (KR) 2020050010051
Apr. 18, 2005 (KR) 2020050010620

(51) Int. Cl. B32B 5/02; B05D 3/02; B05D 3/06; B05D 1/38; E04F 13/00

(52) U.S. Cl. 442/59; 427/532; 427/553; 427/551; 427/202; 156/71; 428/352

(57) ABSTRACT

The present invention provides an anti-adhesion mechanism and a method of producing it and more particularly, it provides an anti-adhesion mechanism comprising a structure body, a resin binder layer comprising a resin binder coated on all or part of the surface of the structure body and a bead layer comprising a plurality of beads bond to the upper side of the coated resin binder layer and being salient outside, and a method of producing an anti-adhesion mechanism comprising coating a resin binder on the surface to be coated, spraying beads on the upper portion of the resin binder before the coated resin binder is hardened and hardening them to form bead protrusions. The anti-adhesion mechanism prepared in accordance with the invention can prevent the adhesion of attachments such as stickers, posters and dusts to the coated surface and easily remove the attachments even though they are adhered, can be readily formed and can improve such properties as weather resistance, contamination resistance, scratch resistance, chemical resistance and impact resistance of the surfaces coated therewith.

### TECHNICAL FIELD

The present invention relates to an structure of preventing sticking (anti-adhesion mechanism) and a method of preparing the same and more particularly, to an anti-adhesion mechanism which can prevent the adhesion of attachments such as stickers, posters, dusts, etc. to the surfaces of road fixtures such as telephone poles, traffic lights, road lamps, traffic signs, and control boxes or their supporters, guardrails, road guide posts, inner and outer frames, walls of buildings or constructs, electric lights or lamp machines and easily remove attachments or dusts even though they are adhered, which can minimize the adhesion of dusts to the surfaces of the structures present in environments where lots of dirt and dusts are readily clung and make removal thereof easy, which can be readily formed, and which can improve such properties as weather resistance, contamination resistance, scratch resistance, chemical resistance and impact resistance of the surfaces coated therewith, and a method of producing it.

### BACKGROUND ART

Generally, a number of various fixtures such as guardrails, road guide posts, inner and outer frames, telephone poles, road lamps, traffic lights, traffic signs and so on are installed on roads, and these fixtures constitute pipes or concrete supporters, which are comprise of even surfaces for the safety of passers.

As illegal advertising materials such as various kinds of stickers and posters were attached to the supporters of the road fixtures or the walls of constructs or buildings by adhesives, glues, etc., they damage the outlook of the supporters, constructs or buildings. Since such advertising materials or attachments have incessantly disfigured beautiful street spectacles, huge budget and labor has been put into removing the advertising materials or attachments.

However, as the supporters of road fixtures have flat sides or rounded pillars and the walls of constructs or buildings are plane surfaces, advertising materials or attachments such as stickers and posters which are composed of papers are readily adhered to them and thus, it is very difficult to monitor and prevent such attachments. Furthermore, once the attachment is done, such advertising materials or attachments as stickers or posters are not completely removed because they are tightly attached to planes, thereby giving rise to the contamination and damage of street spectacles and fixtures.

Hence, there have been various attempts to prevent the adhesion of advertising materials or attachments, but effective prevention methods except simple warning phrases that read, for example, “No Advertisements” or “No attachments” has not been proposed.

Also, a quantity of dusts or contaminants are adsorbed to various constructs such as road guide posts, inner and outer frames, walls, lamp machines or frames thereof, walls of buildings, advertising plates, especially, frames for transparent advertising plates as they are exposed to outsides for long time. Accordingly, there is a great need of methods capable of minimizing the adhesion of such contaminants or dusts and readily removing the adhered dusts or contaminants.

### DISCLOSURE

### Technical Problem

In order to solve the above-mentioned problems, it is an object of the present invention to provide an anti-adhesion mechanism capable of preventing the adhesion of attachments such as stickers, posters, dusts, etc. to the surfaces of road fixtures such as telephone poles, traffic lights, road lamps, traffic signs, and control boxes or their supporters, walls of buildings or constructs, and inner and outer frames and easily removing the attachments even though they are adhered, and a method of producing it.

It is another object of the invention to provide an anti-adhesion mechanism capable of preventing the adhesion of dusts or contaminants to road guide posts, lamp machines, reflecting plates, electric lights and advertising plates and easily removing the dusts or contaminants even though they are adhered, and a method of producing it.

It is a still another object of the invention to provide an anti-adhesion mechanism capable of readily being formed and improving such properties as weather resistance, contamination resistance, scratch resistance, chemical resistance and impact resistance of the surfaces coated therewith and further capable of providing elegant design, and a method of producing it.

### Technical Solution

To achieve the aforementioned objects, the present invention provides an anti-adhesion mechanism comprising:

a structure body;

a resin binder layer comprising a resin binder coated on all or part of the surface of the structure body; and

a bead layer comprising a plurality of beads bond to the upper side of the coated resin binder layer, the beads being salient outside.

Also, the invention provides an anti-adhesion mechanism comprising:

a structure body;

a binder layer comprising a binder coated on all or part of the surface of the structure body;

an adhesion layer comprising a non-woven fabric, woven fabric, foam film or resin film adhered to the binder layer;

a resin binder layer comprising a resin binder coated on the surface of the adhesion layer or the surface of the structure body comprising the adhesion layer; and

a bead layer comprising a plurality of beads bond to the upper side of the coated resin binder layer, the beads being salient outside.

Further, the invention provides a method of producing an anti-adhesion mechanism comprising coating a resin binder on the surface to be coated, spraying beads on the upper portion of the resin binder before the coated resin binder is hardened and hardening them to form bead protrusions.

### ADVANTAGEOUS EFFECTS

In accordance with the anti-adhesion mechanism and the method of producing it in the invention, the protrusions formed through beads on the surfaces of road fixtures such as coated guardrails, telephone poles, traffic lights, road lamps, traffic signs, and control boxes and their supporters, walls of buildings or constructs and inner and outer frames create irregular indentations thereby reducing contact areas between the attachments and the coated surfaces. Accordingly, the invention can prevent the adhesion of such attachments as stickers, posters, dusts, etc. and readily remove the attachments by minimizing the contact areas even though they are adhered. Besides, when the indentations formed by the bead protrusions are tainted with dusts, such contaminants can be readily removed by washing with water such as rain or snow. Thus, the invention shows excellent effects in contamination resistance.

Further, in case of structure bodies easily contaminated by dusts, for example, road guide posts, lamp machines, reflecting plates, electric lights and advertising plates, the invention can prevent the adhesion of dusts or contaminants and readily remove the dusts or contaminants even though they are adhered.

Further, the anti-adhesion mechanism of the invention can be easily formed and improve such properties as weather resistance, contamination resistance, scratch resistance, chemical resistance and impact resistance of the surfaces coated therewith.

The invention is not limited by the detailed description of the invention and the appended drawings. It will be understood by those skilled in this art that other and further changes and modifications may be made without departing from the spirit and scope of the invention which is defined by the claims appended hereto.

### DESCRIPTION OF DRAWINGS

FIG. 1 is a sectional view showing the section of an anti-adhesion mechanism prepared in accordance with the invention.

FIG. 2 is a picture showing a prior road post guard.

FIG. 3 is a picture showing the manufacturing process of an outer frame in accordance with an embodiment of the anti-adhesion mechanism of the invention.

FIG. 4 is a picture showing the outer frame prepared by the process of FIG. 3 in accordance with an embodiment of the invention.

### REFERENCE NUMERALS

1: Surface to be coated (Structure body)
2: Resin binder layer
3: Bead layer

### BEST MODE

The invention is further described in detail with reference to the drawings.

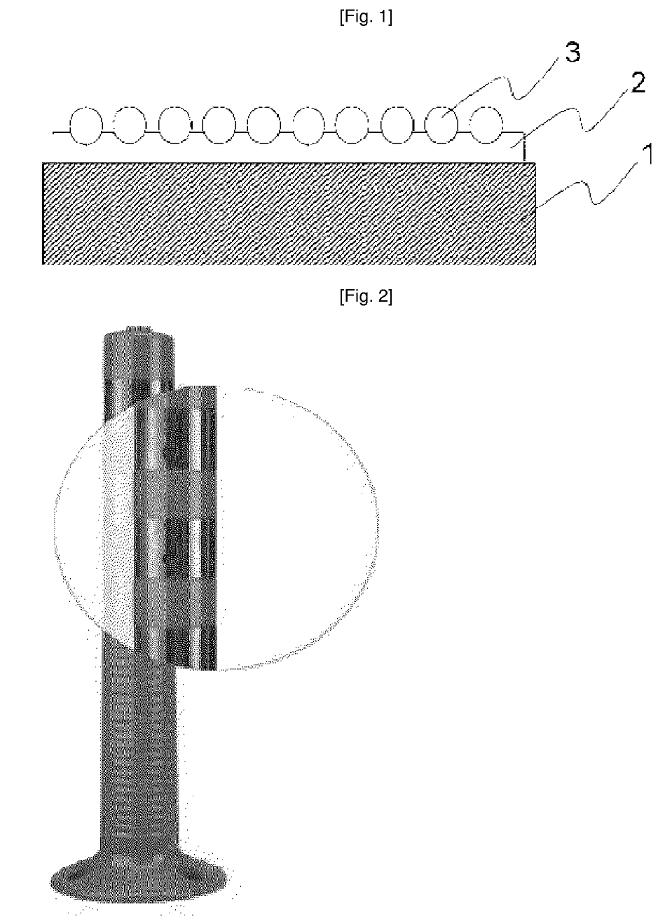

An anti-adhesion mechanism in accordance with an embodiment of the present invention comprises a structure body (1), a resin binder layer (2) comprising a resin binder coated on all or part of the surface (outer, inner planes) of the structure body and a bead layer (3) comprising a plurality of beads bond to the upper portion of the coated resin binder layer and being salient outside. A specific example thereof is shown in FIG. 1.

Such a structure can be constituted by coating a resin binder on the surface of the structure body, spraying beads on the upper portion of the resin binder before the coated resin binder is hardened and hardening them to form a bead layer with bead protrusions formed thereon.

The structure body encompasses all the surfaces to which dusts, stickers, advertising materials or contaminants that are to be removed are adhered and in particular, includes supporters or walls of road fixtures, telephone poles, traffic lights, road lamps, traffic signs, control boxes, buildings, guardrails, road guide posts, inner and outer frames, lamp machines, lamp reflecting planes, electric lights, transparent structures, and advertising plates. The supporters of the road fixtures can be supporters of telephone poles, traffic lights, road lamps, traffic signs, control boxes, etc. and the control boxes can be control boxes of power supply apparatus, traffic lights, road lamps, etc.

In case of road guide posts, as their retroreflection effects are reduced due to the contamination of dusts or contaminants, the invention prevents the adhesion thereof and enables the dusts to be readily removed by wind and rain. The structure body in the invention for the road guide posts encompasses all the structure bodies that are used as the structure body of known road guide posts having various forms and can be various forms including conventional post shape as shown in FIG. 2. It can be made of polyurethanes, other resins, metals, concretes, PVC, FRP, etc. and it includes all kinds of structure bodies for the road guide posts.

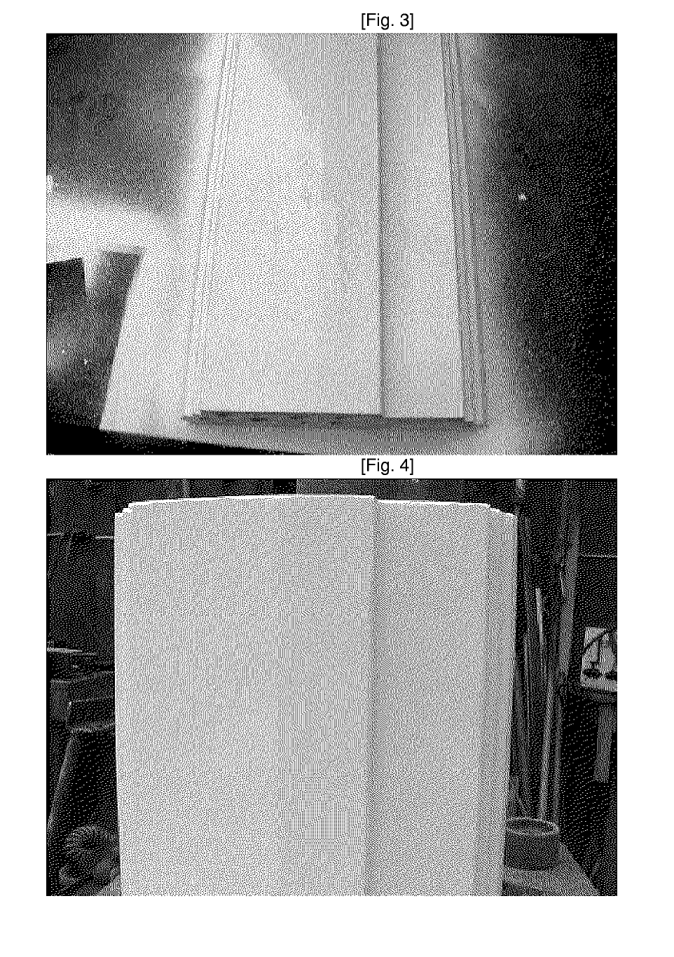

Also, the inner and outer frames encompass all the frames that are used as known inner and outer frames having various forms and they are illustrated in FIG. 3 and FIG. 4. In particular, they are inner and outer frames of constructs, electronic products, machineries, etc. and include inner and outer sashes, inner and outer finishes, electronic apparatus outer frames, machine apparatus outer frames that are bond to outer portions of buildings, devices, machines and more particularly, there can be included various examples such as PVC/aluminum/steel sashes of constructs, computer monitor outer frames, car outer moldings, etc.

In case of lamp machines, as dusts stick well to the lamps, especially, their reflecting planes thereby decreasing luminous intensity, it is advisable to have the anti-adhesion mechanism of the invention for prevention. This effect can be also expected in the lamps themselves. Besides, with regard to transparent structures which are constructs having transparent portions for examples, road advertising plates and bus stops and other advertising materials, it would be advisable to have anti-adhesion mechanism to prevent the adhesion of dusts and make the removal thereof easy.

The resin binder used at the surface of the structure body in the invention functions as a binder, and there can be used resins that are conventionally used for facing. In particular, it is preferable to use one or more resins selected from the group consisting of acryl based resins, ceramic based resins, fluorine based resins, urethane based resins, metallic paints and aqueous binders. For general use, the acryl based resins, ceramic based resins, fluorine based resins, urethane based resins, mixtures thereof are used and when it is applied to lamp machines, the metallic paints are used together therewith whereby reflecting effect can be maximized, and for convenience it would be advisable to use the aqueous resin binders.

For the acryl based resins, there can be used aqueous acrylhydrosol, emulsion solventless-type acryl silane, UV-cured acryl, or solvent-type acryl urethane having methacrylic acid or acrylic acid as a main ingredient.

For the urethane based resins, there can be used ordinary urethane based resins that are used in the pertinent art and for example, there are generally-known thermoplastic resins prepared from organic polyisocyanates and organic compounds containing an active hydrogen atom discovered in hydroxyl portions and amino portions.

For the ceramic based resins, there can be used silicic ester, hydrolysis products thereof, water-dispersible silica sol, or alcohol-dispersible silica sol.

When the resin binder is contained in too low or too high amounts, it is tied up beads and can reduce the coating efficiency when coated on the surfaces of supporters of road fixtures or walls of buildings or constructs and furthermore, overall performances such as intensity, properties, function, etc. are deteriorated.

Preferably, the resin binder has a viscosity within ranges of 1,000 to 200,000 cPs, and various viscosity ranges can be applied depending on coating methods (brushing, spray, impregnation, etc.). Especially, in case of brushing, it is preferred that the viscosity is within ranges of 100,000 to 200,000 cPs, more preferably around 150,000 cPs for the easiness of coating. As the coating methods of the resin binder layer, various known methods can be applied and for example, there can be employed brushing, spray, impregnation, etc.

The resin binder is coated on the surface of the structure body and before the resin binder is hardened, beads are sprayed and adhered onto the upper portion of the resin binder and hardened.

As the hardening methods of the resin binder, various known hardening methods can be applied and in particular, one or more methods selected from the group consisting of natural dry, baking, quenching, catalyst hardening, UV hardening and electron beam hardening can be chosen and employed depending on the type of resin binders (coatings) and they can vary by the type of the resin binders chosen according to their application field and the suitability of forming methods.

The beads used in the invention can be sphere, oval, or any other corresponding shapes and preferably, the sphere shape is used because the sphere beads reduce contact areas between attachments and the coated surfaces by forming bead protrusions on the upper portions of the resin binder. Besides, if air or water comes into the roughness between the bead protrusions formed on the upper portions of the resin binder, air or water spreads out the upper portions of the beads and thus forms air membranes or water membranes thereby reducing the surface tension of objects. Thus, they have a role in preventing the sticking or adhesion of attachments.

As the beads, there can be used those having such shapes and particle sizes that they can form protrusions by protruding above the upper portion of the resin binder as well as by being fixed by the resin binder after they are sprayed onto the upper portion of the resin binder and hardened.

With regard to the shapes of the beads, various known transparent, semi-transparent, or opaque, colorless or color beads can be employed and preferably, transparent beads are used for exterior fine view and retroreflection effects. With regard to the materials of the beads, various known beads for example, ceramic beads, metal beads, resin beads, mixtures thereof can be employed and preferably, glass beads, PMMA beads, zirconia beads or mixtures thereof can be used. Through them, intensity and anti-adhesion characteristics can be increased. More preferably, the glass beads are used in consideration of the intensity of the bead layer, prevention of discoloration and decoloration and static electricity characteristics with the resin binders.

In particular, the glass beads are obtained by treatment of glass powders obtainable by milling glass, cullet, glass fiber, or glass cullet wherein the glass components are not limited to specific ones as long as they are compatible to the resin binders and they include A, C, E, alkali resistance glass powder components, etc.

The glass beads having sphere, oval, or any other corresponding shapes can be used and also, there can be used all kinds of from those where various sizes are distributed to those having only a selected certain size.

The diameter of the beads can be suitably chosen and used according to the material, use, etc. of the structure body surface of the invention and preferably, those having 0.1 nm to 3 mm are used. For general use, those having 0.2 μm to 3 mm are preferable and those having 0.3 to 1.5 mm are more preferable. Further, it is possible to exhibit various morphology and properties by combination of beads having small diameters of several μm and beads having large diameters of several mm. However, if the diameter exceeds 3 mm, the contact areas between the coated surfaces and attachments increase and thus dispersion may be decreased.

When the invention is used as a finish material on walls or in case of a transparent structure body, the size of the beads is preferably 0.02 μm to 3 mm in aspect of costs and elegant design, in case of inner and outer frames, those having 0.01 μm to 0.1 mm are preferable for elegant design and secured bonding, and in case of lamp machines, reflecting planes thereof or lamps themselves, those having 1 nm to 1 nm are preferable for the improvement of luminous intensity and elegant design.

The amount of the beads can be suitably adjusted and used according to the required anti-adhesion performance of contaminants and the material of the coated planes and in particular, they are contained preferably in an amount of 10 to 150 parts by weight, more preferably 50 to 150 parts by weight and much more preferably 70 to 90 parts by weight of 100 parts by weight of the solid resin binder. When the amount is less than 10 parts by weight, the content is too little and anti-contamination effects due to contaminants are thus slight, and when it exceeds 150 parts by weight, the content is relatively high as compared with the resin binder and thus, the beads may fall off after hardening process. Meanwhile, if the invention lays stress on the improvement of contamination, more than 50 parts by weight would be better.

The beads sprayed onto the upper portion of the resin binder before the resin binders are hardened are hardened and fixed by the resin binder (2) coated onto the surface (structure body) (1) and form bead protrusions (3) which protrude above the upper portion of the resin binder (2) as shown in FIG. 1.

Also, when the coating plane is formed on the surface of the structure body, a glass powder can be further added to the resin binder and then coated onto the surface to be coated.

The glass powder does not create gaps by heat shrinkage or expansion by having thermal expansion coefficient similar to the resin binder, thereby improving bonding between the beads and resin binder so that the beads do not fall off or drift away and accordingly, it can effectively prevent the adhesion of contaminants or attachments to the surface of the structure body. In addition, the glass powder inhibits interface separation, absorbs and transfers impacts from outside thereby forming coating plane structure of which the damage is remarkably reduced.

Glass powders having various particle shapes and sizes can be employed as the glass powder, and the particles of the glass powder are those obtainable by milling glass, cullet, glass fiber, or glass cullet wherein the glass components are not limited to specific ones as long as they are compatible to the resin binder and they include A, C, E, alkali resistance glass powder components, etc. Particularly, the glass powder of E-glass components is advisable in aspect of adhesion to various materials.

The diameter of the glass powder is not specially limited, but it is preferably 10 to 1 more preferably 50 to 1. In case of inner and outer frames or lamp machines, as they stress on elegance and use fine beads, it is preferable to use the glass powder of 0.01 to 1. When the diameter of the glass powder is too small, the improvement of bonding between the beads and the resin binder would be slight and when it is too big, it is difficult to evenly mix it with the resin binder, and the intensity of the coating layer may be reduced, or shrinkage and expansion may increase.

The glass powder is contained in an amount of 20 to 50 parts by weight of 100 parts by weight of the solid resin binder. When the amount is less than 20 parts by weight, the bonding-raising effects between the beads and the resin binder is weak and when it exceeds 50 parts by weight, the amount of the resin binder is relatively reduced and thus the adhesion of the coating layer to the surface may be decreased.

Further, when the coating layer is formed, the resin binder may further comprise a glass fiber, if necessary. The glass fiber increases the crack resistance and the tension strength of the hardened anti-adhesion mechanism.

For the glass fiber, E-component long glass fiber or alkali resistance component fiber can be used and in particular, there can be used a chopped fiber which is made by chopping a glass fiber or carbon fiber having a fiber diameter of 10 to 20 into uniform strand length or a milled fiber which is made by milling it into an average fiber length. Especially, it is preferred that the chopped fiber is cut to have a fiber length of 2 to 12 mm and the milled fiber has an average fiber length of 100 to 300. Particularly, the milled fiber is advantageous in consideration of the reinforcement of the tension strength of coating planes and dispersion and there can be also used a mixture of the chopped fiber and the milled fiber.

The glass fiber is contained preferably in an amount of 1 to 100 parts by weight of 100 parts by weight of the solid resin binder. When the amount of the glass fiber is within the above-mentioned ranges, the crack, shrinkage, and expansion of the hardened coating planes do not occur.

Also, the resin binder may further comprise additives such as ordinary filling agents, conductive fillers, pigments, reaction catalysts, thickeners, fluidity adjusters, wetting agents, UV stabilizers, light reflector powders and anti-precipitators if necessary. In particular, the conductive fillers include conductive powders and when included in the resin layer, they inhibit the generation of static electricity by conferring conductive property on the resin layer and maximize contamination resistance. The light reflector powders can improve luminous intensity and provide elegant design when applied to the reflecting planes of lamp machines.

Further, as another structure of the anti-adhesion mechanism of the invention, it can be structured in the form comprising a structure body, a binder layer comprising a binder coated on all or part of the surface of the structure body, an adhesion layer comprising a non-woven fabric, woven fabric, foam film or resin film adhered to the binder layer, a resin binder layer comprising a resin binder coated on the surface of the adhesion layer or the surface of the structure body comprising the adhesion layer, and

a bead layer comprising a plurality of beads bond to the upper side of the coated resin binder layer and being salient outside. The binder can be various known adhesives, and the non-woven fabric, woven fabric, foam film or resin film is not limited to specific ones as long as it is adhered to the structure body in the form of a film, and various known materials (including wallpapers) can be used. Particularly, in case of road guide posts, reflecting papers used in the road guide posts can be included therein. Other structures are the same as the above-described anti-adhesion mechanism.

The entire thickness of the layers formed on the surface of the structure body in the two types of the anti-adhesion mechanisms described above can be adjusted in consideration of the performance or material of the surfaces to be coated and preferably, it is 5 to 3.0 with regard to the surfaces to be coated in aspect of the maintenance of appropriate intensity and the formation of anti-adhesion layers.

Further, the invention provides an anti-adhesion mechanism before bond to the structure body, which comprises an adhesion layer comprising a resin film, foam film, woven fabric or non-woven fabric, a resin binder layer comprising a resin binder coated or impregnated on all or part of the adhesion layer, and a bead layer comprising a plurality of beads bond to the upper side of the coated or impregnated resin binder layer, the beads being salient outside, and the invention can confer anti-adhesion ability on walls by adhering it to the walls in need at necessary time.

Further, the invention provides a method of producing an anti-adhesion mechanism comprising coating a resin binder on the surface to be coated, spraying beads on the upper portion of the resin binder before the coated resin binder is hardened and hardening them to form bead protrusions.

In addition, it provides a method of producing an anti-adhesion mechanism comprising coating a resin binder on a non-woven fabric, woven fabric, foam film or resin film, spraying beads thereon before the coated resin binder is hardened, hardening them and adhering the non-woven fabric, woven fabric, foam film or resin film with bead protrusions formed thereon to the surface to be coated and also provides a method of producing an anti-adhesion mechanism comprising adhering a non-woven fabric, woven fabric, foam film or resin film as a binder to the surface to be coated, coating a resin binder on the surface of the non-woven fabric, woven fabric, foam film or resin film or the surface of a structure body comprising it, spraying beads thereon before the coated resin binder is hardened and hardening them to form bead protrusions.

The resin binder, beads, glass powder, glass fiber and additives used in the method of producing the anti-adhesion mechanism are the same as the above-described anti-adhesion mechanisms.

Also, in the method of producing the anti-adhesion mechanism, as the hardening method of the resin binder, there can be used one or more methods selected from the group consisting of natural dry, baking, quenching, catalyst hardening, UV hardening and electron beam hardening as described above and the viscosity of the resin binder to be coated is preferably within the ranges of 1,000 to 200,000 cPs as described above.

The method of producing the anti-adhesion mechanism of the invention can be carried out by conventional methods and applied to various surfaces of road fixtures such as telephone poles, traffic lights, road lamps, traffic signs, and control boxes or their supporters and walls of buildings or constructs to which advertising materials or attachments are adhered, or other fields besides the above-mentioned places.

As an specific embodiment, the formation of the anti-adhesion mechanism of the invention is carried out first, by directly coating a mixture of a resin binder and if necessary, glass powders, glass fibers, or additives onto the surface of a structure body including the supporters of road fixtures, the walls of buildings or constructs, etc., spraying beads before the coated mixture containing the resin binder is hardened and adhering and hardening the beads on the upper portion of the resin binder or second, by directly coating a mixture of a resin binder and if necessary, glass powders, glass fibers, or additives onto a film including non-woven fabric, woven fabric, etc., spraying beads before the coated mixture containing the resin binder is hardened, adhering and hardening the beads on the upper portion of the resin binder and then adhering the non-woven fabric coated with the above-mentioned components to the surface of a structure body including the supporters of road fixtures, the walls of buildings or constructs, etc. in the manner of a sticker or sheet. The formation of the anti-adhesion mechanism can be done on the surface of a structure body including the supporters of road fixtures or the walls of buildings or constructs that are already present, or it can be formed during the construction of road fixtures, buildings, constructs, etc.

The mixture of the resin binder and if necessary, glass powders, glass fibers, or additives can be coated onto the surfaces to be coated or non-woven fabrics by selectively using conventional coating methods that are used in the pertinent art according to the material, requirements, areas, etc. of the surfaces to be coated. Specifically, when the above components are to be coated in directions other than gravity and thus likely to be scattered, roller or brushing would be advantageous for the prevention of scattering, and when there is no likelihood of scattering, spray coating would be advisable. Third, such an adhesion layer as a non-woven fabric, woven-fabric, foam film or resin film including reflecting papers is adhered to a structure body via a binder. Thereafter, the adhesion layer and the surface of the structure body in contact with the adhesion layer or the surface of the whole structure body are directly coated with a mixture of a resin binder and if necessary, glass powders, glass fibers, or additives and before the coated mixture containing the resin binder is hardened, beads are adhered and hardened on the upper portion of the resin binders by being sprayed thereonto. In the third method, the completed structure body can be a structure comprising the structure body, the binder layer comprising the binder coated onto the surface of the structure body, the adhesion layer comprising the non-woven fabric, woven fabric or resin film adhered to the binder layer, the resin binder layer comprising the resin binder coated onto the outer surface (part or all of the structure body outer surface) of the structure body comprising the adhesion layer, and the bead layer comprising a plurality of beads bond to the upper side of the coated resin binder layer and being salient outside.

Also, the coating plane can be formed on all or part of the surface of the structure body and in case that it is partially formed, it can be constituted in band type and applied to road guide posts, etc.

Also, the coating plane can be formed on the surface of the structure bodies that are already present or it can be produced directly on the surface of new structure bodies during the construction thereof.

In accordance with the method of producing the anti-adhesion mechanism in the invention, the protrusions formed through beads on the surfaces of the above-described structure bodies including supporters of road fixtures for example coated telephone poles, traffic lights, road lamps, traffic signs, and control boxes or walls of buildings or constructs create irregular indentations thereby reducing contact areas between the attachments and the coated planes and thus preventing the adhesion of the attachments and readily removing them by minimizing the contact areas even though they are adhered. Besides, when the unevenness formed by the bead protrusions is tainted with dusts, such contaminants can be readily removed by washing with water such as rain or snow and thus, the invention shows excellent effects in contamination resistance. Further, the anti-adhesion mechanism of the invention can be readily formed and improve such properties such as weather resistance, contamination resistance, scratch resistance, chemical resistance and impact resistance of the surfaces coated therewith.

### MODE FOR INVENTION

For better understanding of the present invention, preferred embodiments follow. The following examples are intended to illustrate the invention more fully without limiting the scope of the invention.

### EXAMPLE 1

Anti-adhesion mechanisms with glass bead protrusions which were adhered to the surface of an urethane resin were prepared by coating 1 kg of urethane resin on a steel, aluminum, resin frame, transparent resin plate, glass and concrete of 25 cm×15 cm, respectively in a thickness of 1 mm, spraying 800 g of glass beads having an average diameter of 0.1 mm before the urethane resin was hardened and hardening them. In particular, the resin frame to which the anti-adhesion mechanism was applied is shown in FIG. 3 and FIG. 4.

Tapes with adhesives thereon were adhered to one side of the above-prepared steel, aluminum, resin frame, transparent resin plate, glass and concrete with the anti-adhesion mechanism, respectively. As a result, tapes did not cling to any one of the steel, aluminum, resin frame, transparent resin plate, glass and concrete. Furthermore, the steel, aluminum, resin frame, transparent resin plate, glass and concrete with the anti-adhesion mechanism were tainted with graphite and then washed with water. As a result, the tainted portions were easily removed.

Therefore, it is verified that the anti-adhesion mechanism prepared in accordance with the invention had excellent anti-adhesion ability and contamination resistance.

### EXAMPLE 2

Anti-adhesion mechanisms were prepared in accordance with the same method as Example 1, with the exception that glass beads having an average diameter of 50 μm were used.

With regard to the steel, aluminum, resin frame, transparent resin plate, glass and concrete with the anti-adhesion mechanism formed thereon, tape adhesion test was carried out in accordance with the same method as used in Example 1. As a result, tapes did not cling to any one of the steel, aluminum, resin frame, transparent resin plate, glass and concrete, and even when strong pressure was applied during adhesion, the tapes were easily detached.

### EXAMPLE 3

After 1 kg of an urethane resin was evenly mixed with 1 kg of a glass powder having an average diameter of 200 meshes and a specific weight of 2.54 and the mixture was coated on a steel, aluminum, resin frame, transparent resin plate, glass and concrete, respectively, anti-adhesion mechanisms were prepared by performing the same method as Example 1. As a result of the tape adhesion test according to the same method as used in Example 1, they showed anti-adhesion effects equal to Example 1.

Further, external pressure was applied to the anti-adhesion mechanisms prepared in Examples 1 and 3 to see whether the glass beads fell off. As a result, the anti-adhesion mechanisms of Example 3 where the glass powder was added showed more excellent bonding ability to glass beads than those of Example 1 where no glass powder was used.

### EXAMPLE 4

After 1 kg of an urethane resin was evenly mixed with 100 g of a milled glass fiber having an average fiber thickness of 13.5 μm and an average fiber length of 300 μm and the mixture was coated on a steel, aluminum, resin frame, transparent resin plate, glass and concrete, respectively, anti-adhesion mechanisms were prepared by performing the same method as Example 1. As a result of the tape adhesion test according to the same method as Example 1, they showed anti-adhesion effects equal to Example 1.

### EXAMPLE 5

After 1 kg of a glass powder having an average diameter of 200 meshes and a specific weight of 2.54 and 100 g of a milled glass fiber having an average fiber thickness of 13.5 μm and an average fiber length of 300 μm were evenly mixed and the mixture was coated on a steel, aluminum, resin frame, transparent resin plate, glass and concrete, respectively, anti-adhesion mechanisms were prepared by performing the same method as Example 1. As a result of the tape adhesion test according to the same method as Example 1, they showed anti-adhesion effects equal to Example 1.

### EXAMPLE 6

An anti-adhesion mechanisms with glass bead protrusions which were adhered to the surface of an urethane resin was prepared by coating 1 kg of urethane resin on a non-woven fabric of 25 cm×15 cm, spraying 800 g of glass beads having an average diameter of 1 mm before the urethane resin was hardened and hardening them. The non-woven fabric with the anti-adhesion mechanism formed thereon was adhered to a steel, aluminum, resin frame, transparent resin plate, glass and concrete and then, tape adhesion was tested using the same method as used in Example 1. As a result, they showed anti-adhesion effects equal to Example 1.

### EXAMPLE 7

Anti-adhesion mechanisms were prepared by performing the same method as Examples 1 to 6 with the exception that PMMA beads were used instead of the glass beads of Examples 1 to 6. As a result of the tape adhesion test, they showed anti-adhesion effects equal to Example 1.

### EXAMPLE 8

Anti-adhesion mechanisms were prepared by performing the same method as Examples 1 to 6 with the exception that zirconia beads were used instead of the glass beads of Examples 1 to 6. As a result of the tape adhesion test, they showed anti-adhesion effects equal to Example 1.

### INDUSTRIAL APPLICABILITY

In accordance with the anti-adhesion mechanism and the method of producing it in the invention, the protrusions formed through beads on the surfaces of road fixtures such as coated guardrails, telephone poles, traffic lights, road lamps, traffic signs, and control boxes and their supporters, walls of buildings or constructs and inner and outer frames create irregular indentations thereby reducing contact areas between the attachments and the coated surfaces. Accordingly, the invention can prevent the adhesion of such attachments as stickers, posters, dusts, etc. and readily remove the attachments by minimizing the contact areas even though they are adhered. Besides, when the indentations formed by the bead protrusions are tainted with dusts, such contaminants can be readily removed by washing with water such as rain or show. Thus, the invention shows excellent effects in contamination resistance.

Further, in case of structure bodies easily contaminated by dusts, for example, road guide posts, lamp machines, reflecting plates, electric lights and advertising plates, the invention can prevent the adhesion of dusts or contaminants and readily remove the dusts or contaminants even though they are adhered.

Further, the anti-adhesion mechanism of the invention can be easily formed and improve such properties as weather resistance, contamination resistance, scratch resistance, chemical resistance and impact resistance of the surfaces coated therewith.

The invention is not limited by the detailed description of the invention and the appended drawings. It will be understood by those skilled in this art that other and further changes and modifications may be made without departing from the spirit and scope of the invention which is defined by the claims appended hereto.

1. An anti-adhesion mechanism comprising:
a structure body;
a resin binder layer comprising a resin binder coated on all or part of the surface of the structure body; and
a bead layer comprising a plurality of beads bond to the upper side of the coated resin binder layer, the beads being salient outside.

2. An anti-adhesion mechanism comprising:
a structure body;
a binder layer comprising a binder coated on all or part of the surface of the structure body;
an adhesion layer comprising a non-woven fabric, woven fabric, foam film or resin film adhered to the binder layer;
a resin binder layer comprising a resin binder coated on the surface of the adhesion layer or the surface of the structure body comprising the adhesion layer; and
a bead layer comprising a plurality of beads bond to the upper side of the coated resin binder layer, the beads being salient outside.

3. An anti-adhesion mechanism comprising:
an adhesion layer comprising a resin film, foam film, woven fabric or non-woven fabric;
a resin binder layer comprising a resin binder coated or impregnated on all or part of the adhesion layer; and
a bead layer comprising a plurality of beads bond to the upper side of the coated or impregnated resin binder layer, the beads being salient outside.

4. The anti-adhesion mechanism according to claim 1 wherein the structure body is a supporter or wall of a road fixture, telephone pole, traffic light, road lamp, traffic sign, control box, buildings, guardrail, road guide post, inner and outer frame, lamp machine, lamp reflecting plane, electric light, transparent structure, or advertising plate.

5. The anti-adhesion mechanism according to claim 1 wherein the resin binder is selected from the group consisting of an acryl based resin, ceramic based resin, fluorine based resin, urethane based resin, metallic paint, aqueous resin binder, and combinations thereof.

6. The anti-adhesion mechanism according to claim 1 wherein the beads are ceramic beads, metal beads, resin beads or mixtures thereof.

7. The anti-adhesion mechanism according to claim 6 wherein the beads are glass beads, PMMA beads, zirconia beads or mixtures thereof.

8. The anti-adhesion mechanism according to claim 1 wherein the beads have an average diameter of 1 nm to 3 mm.

9. The anti-adhesion mechanism according to claim 1 wherein the beads are contained in an amount of 10 to 150 parts by weight of 100 parts by weight of the solid resin binder.

10. The anti-adhesion mechanism according to claim 1 wherein when the resin binder further comprises a glass powder having a diameter of 0.01 μm to 1 mm in an amount of 20 to 50 parts by weight of 100 parts by weight of the solid resin binder.

11. The anti-adhesion mechanism according to claim 1 wherein the resin binder further comprises a chopped fiber which is made by chopping a glass fiber or carbon fiber having a fiber diameter of 10 to 20 μm into uniform strand length or a milled fiber which is made by milling it into average fiber length of 100 to 300 μm in an amount of 1 to 100 parts by weight of 100 parts by weight of the solid resin binder.

12. The anti-adhesion mechanism according to claim 1 wherein the resin binder further comprises one or more additives selected from the group consisting of a filling agent, conductive filler, pigment, reaction catalyst, thickener, fluidity adjuster, wetting agent, UV stabilizer, anti-precipitator, and light reflector powder.

13. The anti-adhesion mechanism according to claim 1 wherein the entire thickness of the layers formed on the surface of the structure body is 5 μm to 3.0 mm.

14. A method of producing an anti-adhesion mechanism comprising coating a resin binder on the surface to be coated, spraying beads on the upper portion of the resin binder before the coated resin binder is hardened and hardening them to form bead protrusions.

15. A method of producing an anti-adhesion mechanism comprising coating a resin binder on a non-woven fabric, woven fabric, foam film or resin film, spraying beads thereon before the coated resin binder is hardened, hardening them and adhering the non-woven fabric, woven fabric, foam film or resin film with bead protrusions formed thereon to the surface to be coated.

16. A method of producing an anti-adhesion mechanism comprising adhering a non-woven fabric, woven fabric, foam film or resin film as a binder to the surface to be coated, coating a resin binder on the surface of the non-woven fabric, woven fabric, foam film or resin film or the surface of a structure body comprising it, spraying beads thereon before the coated resin binder is hardened and hardening them to form bead protrusions.

17. The method of producing the anti-adhesion mechanism according to claim 14 wherein as the hardening method of the resin binder, there are employed one or more methods selected from the group consisting of natural dry, baling, quenching, catalyst hardening, UV hardening and electron beam hardening.

18. The method of producing the anti-adhesion mechanism according to claim 14 wherein the viscosity of the resin binder to be coated is within the range of 1,000 to 200,000 cPs.
